(19) United States
(12) Patent Application Publication
(10) Pub. No.: US 2009/0249603 A1
(43) Pub. Date: Oct. 8, 2009

(54) COLD DEPOSITION REPAIR OF CASTING POROSITY

(76) Inventor: Chris Vargas, Hamden, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/099,275

(22) Filed: Apr. 8, 2008

(51) Int. Cl. B23P 6/04; F01N 7/10; B32B 5/18

(52) U.S. Cl. 29/402.18; 60/323; 428/613

(57) ABSTRACT

A method of repairing a component having interconnected porosity applies a material to the area of the porosity through a cold deposition process. Components repaired by this method are also claimed.

### BACKGROUND OF THE INVENTION

This application relates to a method of depositing additional material at selected locations on a cast part to close an interconnected porosity.

Many components are formed by casting for various applications. One application that generally utilizes a cast component is a fluid manifold for a gas turbine engine. The fluid manifold may be used for any number of fluids, e.g., fuel, oil, air, etc. The fluid manifold is generally cast of an aluminum alloy, but may also be cast titanium alloy or cast steel. At least some known castings generally contain porosity as a result of the casting process and generally are hot isostatically pressed to close or minimize the amount of porosity. The porosity of such known casting is generally open to outermost surfaces of the casting even with the hot isostatic pressing process because there is a lack of differential pressure between the pore and external atmosphere.

To ensure that robust fluid manifolds are produced, such manifold are generally put through a series of acceptance tests. One acceptance test that is performed on the cast fluid manifold is a pressure test to determine whether the manifold is able to withstand internal pressures in use by preventing the pressurized test fluid such as, but not limited to, water that is located in the internal cavities of the manifold from communicating with the external environment. If the manifold is unable to withstand the internal pressures, then the manifold is either repaired or scrapped. One cause for a fluid manifold failing the pressure test would be if there is continuous or interconnected porosity between an inner surface and an outer surface of a wall of the manifold. In such instances, fluid may leak outwardly from the internal cavity of the component.

Several aluminum alloys are designated as “A” by the Aluminum Association. One in particular has been gaining use in forming fluid manifolds. That alloy is designated A201, and is a Al—Cu alloy.

At least one known method of repairing casting porosity is to remove an external surface area at the location of the interconnected porosity, and add new material via a weld. However, the interconnected porosity of the cast component makes it difficult to produce sound welds that effectively seal the manifold. In addition, some fluid manifolds, and in particular those formed of aluminum alloy A201 are extremely difficult to weld.

Another known method for repairing casting porosity is to vacuum impregnate the fluid manifold with a low viscosity polymer, such as Loctite® Resinol® RTC, to seal the porosity. Also, Loctite® Resinol® 90C™ may be used, as may be other materials. However, such known method limits the maximum temperature through which the part may be used. For example, the maximum temperature may be below a glass transition temperature of the polymer.

Cold spray has been utilized to deposit materials, such as aluminum alloys, to repair defects on parts that have sustained damage from use. However, known cold spray methods do not overcome the interconnected porosity problem mentioned above.

### SUMMARY OF THE INVENTION AND ADVANTAGES

A method of repairing a component having interconnected porosity applies a material to the area of the porosity through a cold deposition process. Components repaired by this method are also claimed.

These and other features of the disclosed embodiments may be understood from the following specification and drawings, the following of which is a brief description.

### BRIEF DESCRIPTION OF THE DRAWINGS

FIG. 1A shows an exemplary cast component having an example area of interconnected porosity.

FIG. 1B is a cross-sectional view schematically showing the interconnected porosity.

FIG. 1C is a micrograph of an area containing interconnected porosity in a cast component that leaked during a pressure test.

FIG. 2A shows a repaired component.

FIG. 2B shows a first step in a first embodiment of performing the repair.

FIG. 2C shows a subsequent step.

FIG. 2D shows yet another step.

FIG. 3 shows a second embodiment.

### DETAILED DESCRIPTION OF THE PREFERRED EMBODIMENT

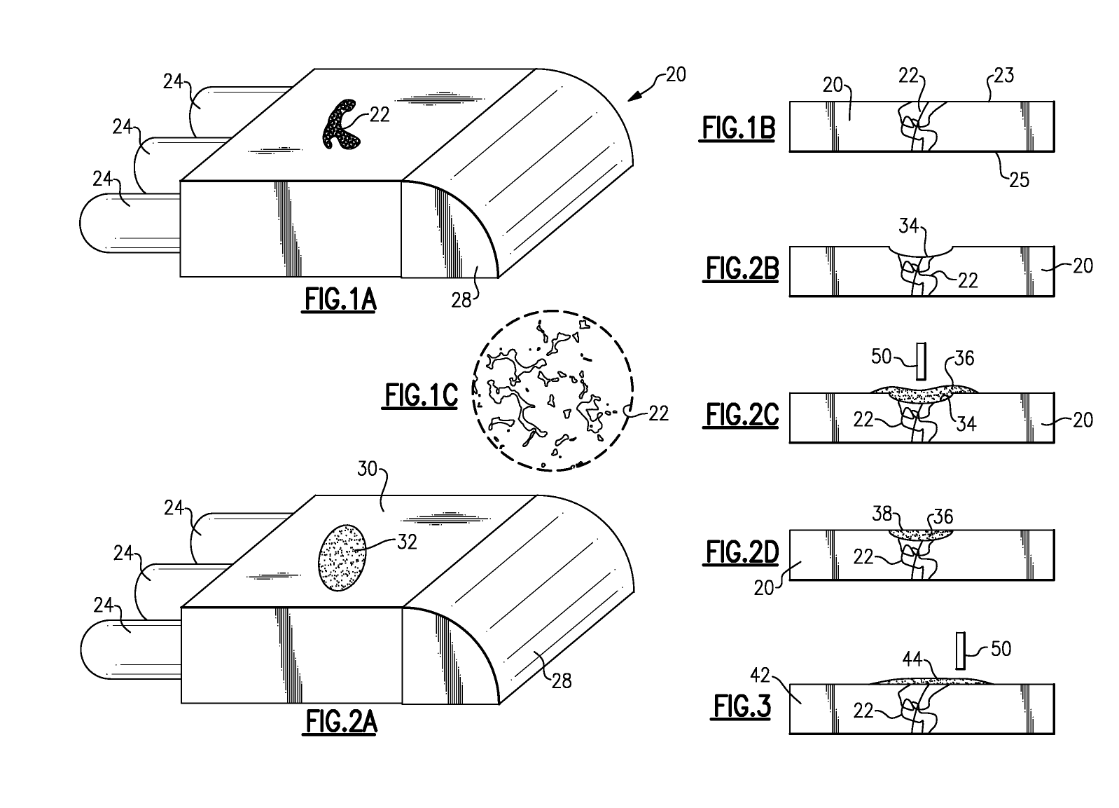

An exemplary cast component such as fluid manifold 20 is illustrated in FIG. 1A. Although the component is described as fluid manifold 20, it should be appreciated that the component may be a fuel manifold, other fluid manifold, or other cast component. An area of interconnected porosity 22 is shown schematically on a body of the fluid manifold. As shown, fluid tubes 24 extend to different locations to distribute fluid, and a manifold member 28 serves to communicate fluid to the tubes 24. As known, the interior of the manifold 20 must be able to withstand high pressures. However, as shown in FIGS. 1B and 1C, interconnected porosity 22 challenges the ability of the manifold 20 to withstand internal pressures. As shown in FIG. 1B, the porous areas extend from an outer face 23 entirely through to an inner face 25 of a wall. In such instances, fluid leaks between the two faces, and the manifold 20 would not be able to hold the fluid back from flowing from the inner face 25 to the outer face 23 as a result of internal pressures. FIG. 1C shows a micrograph of a sectioned manifold, such as manifold 20, in an area that leaked during pressure test as a result of the interconnected porosity 22. It should be appreciated that the component may be cast from aluminum alloy, titanium alloy, or steel.

FIG. 2A shows a repaired manifold 30, having an area of repair 32 at the location of the interconnected porosity 22.

As shown in FIG. 2B, an initial step is to remove material in an area 34 associated with an interconnected porosity 22 by mechanical or chemical means, such as grinding, machining, etching, or other applicable techniques. The depth of the blend can range from 0.25 mm to 2 mm with a length of the blend being on the order of at least 20 times the depth. The resultant surface may or may not be grit blasted with aluminum oxide or other acceptable media. The prepared surface is then cleaned by wiping and/or flushing with a solvent, such as isopropyl alcohol. Then, as shown in FIG. 2C, a suitable material is deposited via cold spray deposition, such as shown in 36, onto a cut away portion 34 by a cold spray nozzle 50. Any other deposition processes may be used to provide sufficient energy to accelerate particles to a high enough velocity such that, upon impact, the metal particles deform and bond to the surface, building a relatively dense coating or structural deposit. The surface may be the prepared manifold surface or a previously deposited metal layer. The deposition process does not metallurgically transform the particles from their solid state. Various techniques to achieve this type of particle deposition have been evaluated and reduced to practice such as cold gas dynamic spraying (cold spray deposition), kinetic metallization, electromagnetic particle acceleration, modified high velocity air fuel spraying, or high velocity impact fusion (HVIF). These are examples of high velocity deposition processes where metallurgical transformation of powder metal particles is not encountered. Although the cold spray deposition process is disclosed, it should be appreciated that other cold deposition processes may be used.

Suitable aluminum containing materials, with a composition of at least 50% aluminum, which may be deposited include, but are not limited to, pure aluminum, aluminum alloy A201, the base alloy, aluminum alloy 2014, aluminum alloy 2024, aluminum alloy 2219, aluminum alloy 6061. Again, these are Aluminum Association designations. The following type alloys can also be used: Al-12Si alloy, Al—Sc alloy, and aluminum alloy 6061/B4C, and others.

In disclosed embodiments, a blending or grit blasting technique is used to form the area 34. Any known machining process may be used to move to a substantially flush surface or face 38 as shown in FIG. 2D or the deposited material may be left as deposited. It should be appreciated that the flush surface 38 is substantially flush with respect to the outer face 23. If the cold spray deposit is applied after the manifold's hot isostatic press, solution, and precipitation heat treatments, the cold spray deposit may be heat treated to relieve any residual stresses and to improve the deposits ductility at 35° C. to 260° C. for 1 hour to 24 hours. The heat treatment may be applied locally in the area of repair or globally to the entire manifold 20.

As shown in FIG. 3, in another embodiment, fluid manifold 42 may receive a cold spray coating at 44, without any of the surface blending at the outer face. The surface may be grit blasted and cleaned with a suitable solvent prior to the cold spray process. The deposit may be finished machined to produce the desired surface finish on the raised cold spray deposit. The deposit may also be left unfinished.

After the manifold 20 is repaired, it will be put through acceptance testing to facilitate ensuring a robust manifold and repair. If necessary, the manifold 20 may go through the repair process multiple times.

In an exemplary method, a component is cast. The cast component is tested to identify any areas of interconnected porosity, which allow fluid communication between the interior cavities and the exterior environment. If such an area is identified, then the technique of FIG. 2B-2D, or the technique of FIG. 3 may be utilized. The cold spray deposition may be applied prior to or after a hot isostatic pressing treatment of the casting.

Although embodiments have been disclosed, a worker of ordinary skill would recognize that certain modifications would come within the scope of this invention. For that reason, the following claims should be studied to determine the true scope and content of this invention.

What is claimed is:

1. A method of repairing a cast component, the method comprising:
a) identifying an area of interconnected porosity in the component; and
b) depositing a material onto the area of interconnected porosity to close off the pores through a cold deposition process.

2. The method as set forth in claim 1, wherein the area is initially removed at a blend surface to receive the material.

3. The method as set forth in claim 2, wherein a surface area of the blend surface is of a dimension at least twenty times a depth of the blend surface.

4. The method as set forth in claim 2, wherein the material is removed to create a flush surface after deposition.

5. The method as set forth in claim 1, wherein the material is applied directly to a face of the component, and is left to extend outwardly of the face.

6. The method as set forth in claim 1, wherein the component is a fluid manifold for a gas turbine engine.

7. The method as set forth in claim 6, wherein the fluid manifold is cast from an aluminum alloy, and the material is also an aluminum alloy.

8. A fluid manifold for a gas turbine engine, the fluid manifold comprising:
a fluid manifold body having a wall with an inner face and an outer face, and being cast from an aluminum alloy; and
a material deposited by a cold deposition process on said outer face of said wall on an area wherein pores extend from the material continuously to the inner face.

9. The fluid manifold as set forth in claim 8, wherein the area is initially removed at a blend surface to receive the material.

10. The fluid manifold as set forth in claim 9, wherein a surface area of the blend surface is of a dimension at least twenty times a depth of the blend surface.

11. The fluid manifold as set forth in claim 8, wherein the material is flush with the outer face.

12. The fluid manifold as set forth in claim 8, wherein the material is applied directly to the outer face, and extends outwardly of the outer face.

13. The fluid manifold as set forth in claim 8, wherein the material contains aluminum.

14. The fluid manifold as set forth in claim 13, wherein the material is an aluminum alloy.

15. A cast component comprising:
a body having a wall with an inner face and an outer face, and being cast from an aluminum alloy; and
a material deposited by a cold deposition process on said outer face of said wall on an area wherein pores extend from the material continuously to the inner face.

16. The component as set forth in claim 15, wherein the area is initially removed at a blend surface to receive the material.

17. The component as set forth in claim 16, wherein a surface area of the blend surface is of a dimension at least twenty times a depth of the blend surface.

18. The component as set forth in claim 15, wherein the material is flush with the outer face.

19. The component as set forth in claim 15, wherein the material is applied directly to the outer face, and extends outwardly of the outer face.

20. The component as set forth in claim 15, wherein the material contains aluminum.
